(19) United States
(12) Patent Application Publication
(10) Pub. No.: US 2021/0081003 A1
(43) Pub. Date: Mar. 18, 2021

(54) INTERACTIVE DISPLAY SYSTEM WITH MULTIFUNCTIONAL PRIVACY SWITCH

(71) Applicant: Facebook Technologies, LLC, Menlo Park, CA (US)

(72) Inventors: Peter Wesley Bristol, Seattle, WA (US); Chunli Chen, Seattle, WA (US); Tomas Brennessl, San Francisco, CA (US)

(21) Appl. No.: 16/574,988

(22) Filed: Sep. 18, 2019

Related U.S. Application Data
(60) Provisional application No. 62/899,923, filed on Sep. 13, 2019.

(51) Int. Cl. G06F 1/16; G06F 21/83

(52) U.S. Cl. CPC G06F 1/1656; G06F 21/83; G06F 1/1675; G06F 1/1686

(57) ABSTRACT

An interactive display system may include (i) a housing surrounding at least a portion of a display region, (ii) a camera for capturing images via a camera opening defined in the housing, (iii) a microphone for capturing audio content, and (iv) a privacy switch assembly including a sliding member that is movable between a plurality of set positions. The plurality of set positions may include (i) a first position at which a field of view of the camera is unobstructed and the microphone is active, (ii) a second position at which a shutter of the privacy switch assembly blocks the field of view of the camera or the microphone is disabled, and (iii) a third position at which the shutter blocks the field of view of the camera and the microphone is disabled. Various other systems, devices, assemblies, and methods are also disclosed.

### CROSS REFERENCE TO RELATED APPLICATION

This application claims the benefit of U.S. Provisional Application No. 62/899,923, filed 13 Sep. 2019, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a front perspective view of an exemplary display system according to some embodiments of this disclosure.

FIG. 2 is a front perspective view of the display system of FIG. 1 according to some embodiments.

FIG. 3 is a perspective view of the display system of FIG. 1 according to some embodiments.

FIG. 4 is a cutaway front perspective view of the display system of FIG. 1 illustrating details of a privacy switch assembly according to some embodiments.

FIG. 5A is a top view of a portion of an exemplary display system illustrating details of a privacy switch assembly in a first position according to some embodiments.

FIG. 5B is a top view of the portion of the display system of FIG. 5A illustrating details of the privacy switch assembly in a second position according to some embodiments.

FIG. 5C is a top view of the portion of the display system of FIG. 5A illustrating details of the privacy switch assembly in a third position according to some embodiments.

FIG. 6A is a front view of an exemplary privacy switch assembly in a first position according to some embodiments.

FIG. 6B is a top view of the privacy switch assembly of FIG. 6A in the first position according to some embodiments.

FIG. 7A is a front view of the privacy switch assembly of FIG. 6A in a second position according to some embodiments.

FIG. 7B is a top view of the privacy switch assembly of FIG. 6A in the second position according to some embodiments.

FIG. 8A is a front view of the privacy switch assembly of FIG. 6A in a third position according to some embodiments.

FIG. 8B is a top view of the privacy switch assembly of FIG. 6A in the third position according to some embodiments.

FIG. 9A is a rear view of the privacy switch assembly of FIG. 6A in the first position according to some embodiments.

FIG. 9B is a rear view of the privacy switch assembly of FIG. 6A in the third position according to some embodiments.

FIG. 10 is a flow diagram of an exemplary method for operating a privacy switch assembly of an interactive display system according to some embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to interactive display systems having privacy switch assemblies for enhancing protection of user privacy. Display systems with a variety of interactive features are becoming increasingly commonplace in homes and businesses. People commonly use interactive displays, such as smart displays, that are easily accessible and can provide hands-free access to the online world and expressive interactive communication experiences with other remote users. The interactive displays commonly include microphones that allow users to easily interface with the devices using voice commands and remotely communicate with family, friends, and colleagues. The display devices also frequently include cameras to allow for image and video sharing, providing an enhanced level of interaction and connection while interacting with other parties. However, features such as microphones and cameras, which are often controlled by internal circuitry in the interactive displays, may cause privacy concerns for user's who may be wary of images and/or audio being inadvertently captured without their knowledge. While indicators may be displayed on a screen of such displays to provide reassurance to users that the microphone is muted or the camera is inactive, such visual graphics may take up screen space, diminishing a user's viewing experience and, in many cases, leaving a sense of uncertainty as to whether the components are in fact non-operational, particularly in light of instances where individuals have been inadvertently or maliciously recorded by computer-controlled in-home camera and audio devices. In some instances, users may place a physical cover over the camera to block its view, adding a layer of inconvenience to these users and potentially exposing other users who are less aware of security concerns to privacy breaches.

As will be explained in greater detail below, embodiments of the present disclosure may provide an interactive display system that provides a greater degree of privacy to users via a physical privacy switch assembly that can be easily operated to deactivate microphones and/or to physically block a camera of the system. The privacy switch assembly may provide a visible indication of the privacy state of the microphones and camera that can be seen by individuals while using the display system. For example, an exemplary display system may include a privacy switch assembly that is located near a display surface and that includes visual graphics that instantly convey the current state of the microphones and camera without interfering with content displayed on the display surface. Additionally, the privacy switch assembly may include a shutter that covers and blocks the camera in a manner that is readily apparent to users. In various examples, the privacy switch assembly may include a sliding member that the user moves between various positions along a single path to enable/disable either or both of the microphone and the camera, allowing for simple user-friendly operation.

Features from any of the embodiments described herein may be used in combination with one another in accordance with the general principles described herein. These and other embodiments, features, and advantages will be more fully understood upon reading the following detailed description in conjunction with the accompanying drawings and claims.

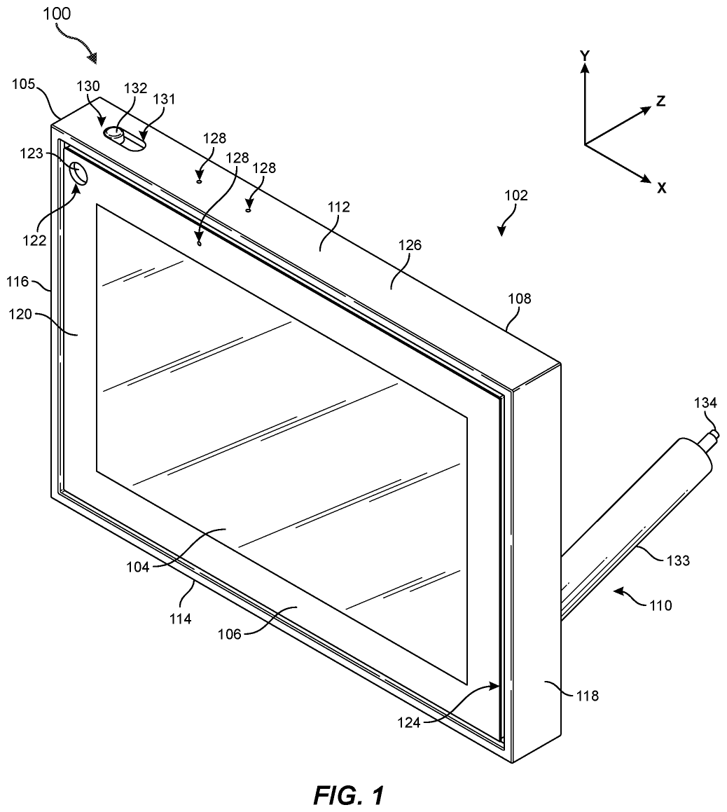

The following will provide, with reference to FIGS. 1-10, detailed descriptions of interactive display systems including multifunctional privacy switch assemblies and corresponding methods.

FIGS. 1-3 illustrate an exemplary interactive display system in accordance with various embodiments. As shown in these figures, display system 100 may include a display device 102 that is configured to provide a user with an interactive visual and/or audio experience. Display device 102 may include various features to facilitate user interaction with display device 102 for purposes of communication with other users via an online environment. In some examples, display device 102 may also enable users to access various applications and/or online content. Display device 102 may include any suitable hardware components, including at least one physical processor and at least one memory device, and software tools to facilitate such interactions. In at least one example, display device 102 may be connected to an online and/or other networked environment via, for example, a Wi-Fi, cellular, Bluetooth, and/or a wired connection.

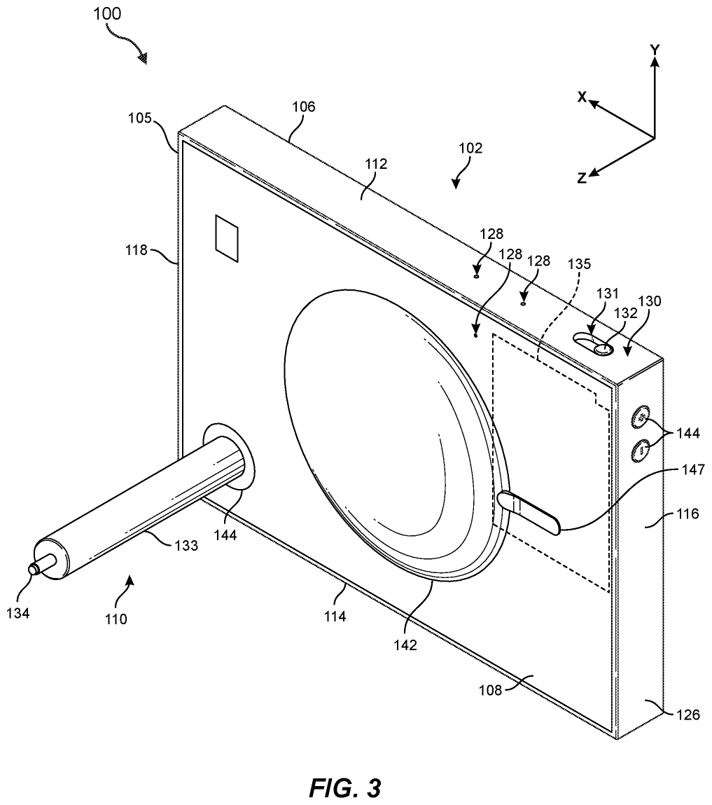

In various embodiments, display device 102 may include a controller 135 as illustrated, for example, in FIG. 3. Controller 135 may include any suitable system having one or more computing devices that control operation of one or more components of display device 102. For example, controller 135 may communicate with and control operation of a camera 136 and/or one or more microphones 129 of display device 102. In some examples, controller 135 may also control operation of various other components, such as a display screen that displays content visible on display surface 104, an audio system that produces sound emitted by speakers in display device 102, and/or any other suitable components of display system 100. Controller 135 may be disposed in any suitable location. For example, controller 135 may be disposed within housing 105 and, in some embodiments, may be disposed on a printed circuit board. Controller 135 may include at least one physical processor and at least one memory device and may be communicatively coupled with various components (e.g., via electrical wiring and/or circuitry within display device 102), such as camera 136 and/or one or more microphones 129, allowing for signals to be sent to and received from the components.

Display device 102 may include a housing 105 having any suitable exterior surface shape, such as a shape having a rectangular or substantially rectangular periphery. In some embodiments, as illustrated in FIGS. 1-3, housing 105 may include exterior sides having planar or substantially planar surfaces and/or surface portions that intersect at angular, rounded, and/or beveled junctions. For example, housing 105 of display device 102 may include a front side 106, a back side 108, a top side 112, a bottom side 114, a left side 116, and a right side 118. At least a portion of front side 106, back side 108, top side 112, bottom side 114, left side 116, and/or right side 118 may extend parallel to at least two of the illustrated X-, Y-, and Z-axes.

Front side 106 of display device 102 may include a display surface 104 that provides visual content to a user. According to various embodiments, display device 102 may include an array of pixels for displaying images and/or video viewable via a display surface 104. For example, display device 102 may include a liquid crystal display (LCD), light-emitting diode (LED) display, organic light-emitting diode (OLED) display, an inorganic light emitting diode (ILED) display, an active-matrix organic light-emitting diode (AMOLED) display, or any other suitable display technology. In some examples, display device 102 may include an integrated touch sensor at or near display surface 104, such as a mutual capacitance touch sensor, a self-capacitance touch sensor, an inductive touch sensor, or any other suitable touch sensor technology that allows for user touch-based interaction via display surface 104.

In various embodiments, display surface 104 may have a rectangular or substantially rectangular periphery. Display device 102 may be configured to display images and/or video on display surface 104 in any orientation, including, for example, landscape and portrait orientations. In some examples, display device 102 may detect its current orientation (e.g., using at least one gyroscope and/or other suitable orientation sensor, or via manual input) and automatically display an image with the top of the image displayed at the top of display surface 104 such that the image appears in a correct orientation for the viewer regardless of the orientation of the display device 102.

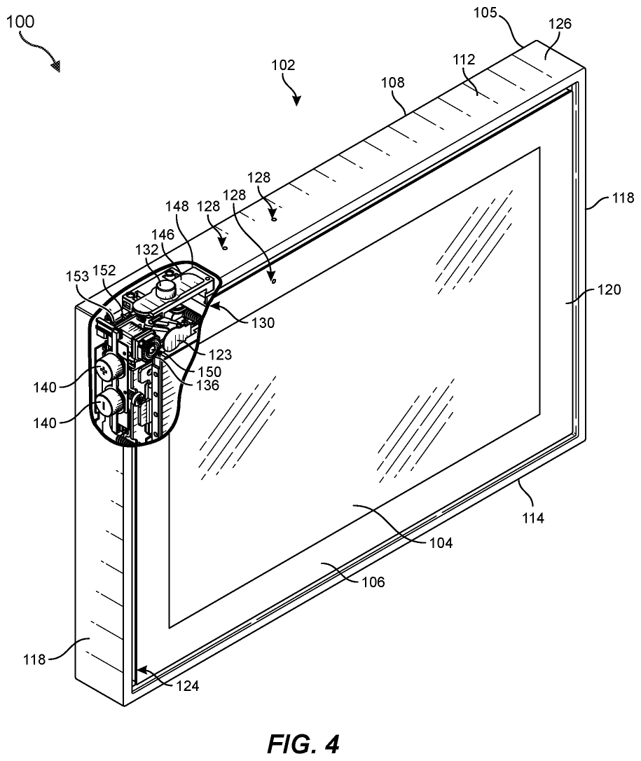

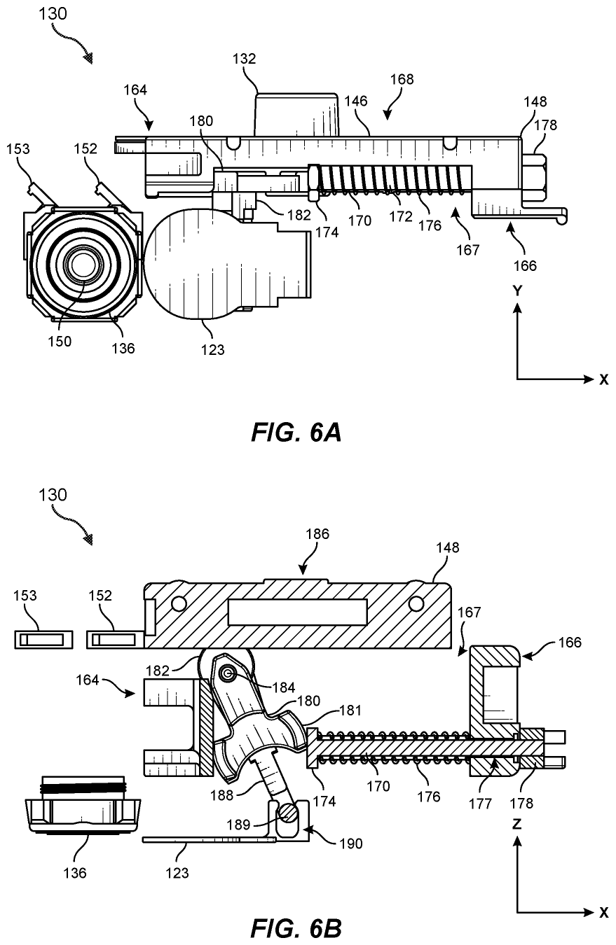

In at least one embodiment, front side 106 of display device 102 may include a frame region 120 peripherally surrounding display surface 104. A camera opening 122 for a camera 136 (see FIG. 3) within display device 102 may be defined in frame region 120 at or near a corner of frame region 120. For example, camera opening 122 may be disposed near an intersection of top side 112 and left side 116 of display device 102. Camera opening 122 may allow passage of light to camera 136 to capture images and/or video from a local environment. As used herein, a camera may generally refer to any camera device suitable for capturing images, such as photographic and/or video images, from an environment surrounding display device 102. Examples of cameras may include, without limitation, digital cameras that convert captured light into digital signals, such as cameras having charge-coupled device (CCD) image sensors, cameras having complementary metal-oxide semiconductor (CMOS) image sensors, and/or any other suitable camera device. A camera may include an image sensor array, a lens or lens array (e.g., camera lens 150 in FIGS. 4 and 6A) to focus light on the image sensor array, and an aperture that allows light to enter the camera. The image sensor array may include a plurality of pixel sensors (e.g., light-sensing photodiode elements) that capture and measure light emitted from various portions of the display. In some examples, the camera device may also include a microlens array to further focus light on the pixel sensors.

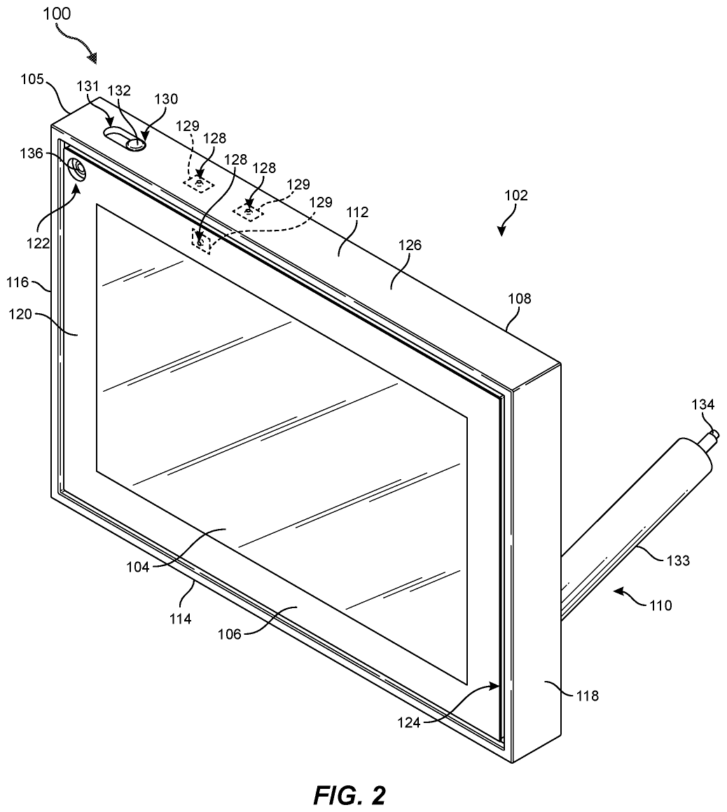

As shown in FIGS. 1 and 2, display device 102 may also include an audio trench 124 disposed between frame region 120 and a surrounding peripheral region 126 of display device 102. Audio trench 124 may facilitate transmission of sound from speakers concealed within display device 102 to provide high-quality audio content to a user via front side 106. In some examples, display device 102 may include one or more speakers for generating sound that is audible via, for example, audio trench 124. The speakers may include, for example, one or more speakers disposed within housing 105, such as a woofer, which may be covered by a speaker cover 142 (e.g., a grill, mesh, screen, etc.) protruding from back side 108 as illustrated, and/or a pair of tweeters that emit sound via audio trench 124. In one example, display device 102 may also include a port cover 147 that, for example, covers a port for connecting one or more cables (e.g., a USB cable, an HDMI cable, etc.). Display device 102 may also include various other components, such as volume buttons 140 located, for example, on left side 116 (see, e.g., FIG. 2) and/or any other suitable location. Volume buttons 140 may be utilized by a user to adjust the volume of audio produced by display device 102.

In some examples, display device 102 may include one or more microphones 129 within housing 105 that receive audio from a surrounding environment via one or more corresponding microphone openings 128 defined in, for example, top side 112, front side 106, and/or back side 108. Microphones 129 may be positioned and configured to pick up sound from various directions in the local environment around display device 102. As used herein, a microphone may generally refer to any transducer device suitable for receiving and converting sound (i.e., air pressure variations of sound waves) into electrical signals, which may be amplified (e.g., using a preamplifier) and converted from analog to digital signals (e.g., using a digital to analog convertor, DAC). Examples of microphones may include, without limitation, dynamic microphones, the condenser microphones, piezoelectric microphones, fiber optic microphones, microelectromechanical systems (MEMS) microphones, and/or any other suitable types of microphones.

In various examples, peripheral region 126 of display device 102 may include top side 112, bottom side 114, left side 116, right side 118, and peripheral portions of front side 106 and/or back side 108 of display device 102. In some examples, at least a portion of peripheral region 126 may include a material that provides a suitable degree of stiction with respect to a variety of surface types to prevent sliding of display device 102 during use. Such a material may also have vibration damping properties to absorb acoustic vibrations generated by the display audio system. For example, peripheral region 126 may include an elastomeric layer (e.g., including a polyurethane polymer, such as thermoplastic polyurethane, TPU, and/or any other suitable elastomer).

According to various embodiments, display system 100 may include a support stand 110, which may function as an integrated positioning and power supply assembly. As shown in FIGS. 1-3, support stand 110 may be coupled to display device 102 to provide mechanical support and electrical power to display device 102. Support stand 110 may include a coupling member 144 that is mounted to display device 102 at back side 108 (see FIG. 3) near, for example, an intersection of bottom side 114 and right side 118 to support display device 102 in both landscape and portrait orientations. Camera 136 may be positioned adjacent front side 106 near an intersection of top side 112 and left side 116 (see FIG. 1) so that camera 136 is disposed in close proximity to a top edge of display surface 104 when display device is positioned in either of the landscape and portrait orientations to facilitate capture of a user and their surroundings while the user views and interacts with content displayed on display surface 104. Support stand 110 may further include an elongated support member 133 for physically supporting display device 102 in a selected orientation on an external surface, as will be described in greater detail below. Electrical wiring for supplying power to display device 102 may extend from display device 102 through an interior of support member 133. An electrical cord 134 for providing electrical power to display device 102 may protrude from a portion (e.g., a distal end) of support member 133.

According to at least one embodiment, display device 102 may also include a privacy switch assembly 130 that is accessible, for example, at top side 112. As will be described in greater detail below, privacy switch assembly 130 may include a positioning protrusion 132 that is located at an exterior portion of display device 102 that is clearly visible and accessible to a user. For example, positioning protrusion may protrude through an elongated opening 131 defined in an exterior side portion of housing 105, such as top side 112. Positioning protrusion 132, which may be fixed to a sliding member (see sliding member 148 in FIG. 4), may be slidable by a user along a path (e.g., a linear path, an arcuate path, etc.) that extends lengthwise along elongated opening 131 to enable selection between various privacy modes in which camera 136 and/or microphones 129 of display device 102 are enabled or disabled. In some examples, a camera shutter 123 may be positionable by privacy switch assembly 130 to cover at least a portion of camera opening 122 and block the field of view of camera 136, as shown in FIG. 1. Additionally, as shown in FIG. 2, camera shutter 123 may be positioned via privacy switch assembly 130 so that it does not overlap camera opening 122, thereby allowing camera 136 to capture images from the local environment. Camera 136 may be configured to receive light from a field of view and generate pictures and/or video of a portion of the local environment within the field of view. In at least one example, camera 136 may have a wide field of view to allow for image capture of one or more users and/or objects in a variety of locations in the local environment.

According to some embodiments, at least one computer-implemented application executed by one or more physical processors of display device 102 and/or external to display device 102 may identify the presence of one or more users and/or user features (e.g., facial features, hands, etc.) and may locate and/or track their location in the field of view of camera 136. In some examples, the at least one application may zoom, pan, crop, and/or otherwise modify one or more portions of a captured image to digitally enhance a viewing experience for other users receiving such images (e.g., other users communicating remotely with a user of display device 102). In various examples, the at least one application may add image elements to images captured by camera 136 and/or may obscure portions of the captured images to generate enhanced or artificial-reality images and/or to block the appearance of selected objects in the field of view of camera 136. Such applications may be utilized to produce images that are visible to a user on display device 102 and/or to other users in communication with display device 102 via, for example, a connected network.

Additionally or alternatively, the at least one application may be utilized to perform various operations on display device 102. For example display device 102 may be operated in an ON state during which images and/or audio are captured and/or presented by display device 102 when an individual is detected within at least a portion of the field of view of camera 136. Display device 102 may be switched to a standby or OFF state when an individual is not detected within at least the portion of the field of view of camera 136 (e.g., after an individual has been absent from the field of view fora threshold period of time). In some examples, images captured by camera 136 may be utilized for biometric purposes to identify physical features of an individual (e.g., facial features) and limit access to allow only authorized users. Additionally or alternatively, user gestures (e.g., hand, arm, and/or facial gestures) for controlling various operations of display device 102 (e.g., volume control, image adjustment, ON/OFF state, etc.) may be detected via images captured by camera 136. In some examples, the at least one application may use images captured by camera 136 in conjunction with audio captured by microphones 129 of display device 102 to perform various functions, such as one or more operations described above.

FIG. 4 is a cutaway view of display system 100 showing certain internal components within housing 105 of display device 102, including privacy switch assembly 130. As shown, privacy switch assembly 130 may include a sliding member 148 fixed to positioning protrusion 132, which extends through elongated opening 131 (see FIGS. 1-3). As will be described in greater detail below, sliding member 148 may be slidably moved by a user via, for example, positioning protrusion 132 to selectively enable or disable camera 136 and/or microphones 129. As shown in FIG. 4, privacy switch assembly 130 may include one or more switches, such as a primary switch 152 and a secondary switch 153, that may be triggered when sliding member 148 is in certain predetermined positions. In various embodiments, sliding member 148 may be moved to reposition camera shutter 123 from, for example, a position outside the field of view of camera 136, as shown in FIG. 4, to a position covering camera lens 150 and blocking a field of view of camera 136. According to various embodiments, privacy switch assembly 130 may be located in close proximity to camera 136 to facilitate positioning of camera shutter 123 in front of camera 136, and additionally, to ensure that privacy switch assembly 130 is located in a region of display device 102 that is clearly visible and easily accessible to a user.

In some examples, sliding member 148 may include a privacy indicator surface 146 that is positioned so as to be visible to a user via, for example, elongated opening 131. Privacy indicators surface 146 may include indicator graphics and/or other surface features that visually indicate a current privacy state of display device 102. For example, privacy indicator surface 146 may be configured to instantly convey to a user whether camera 136 and/or microphones 129 are presently active or inactive.

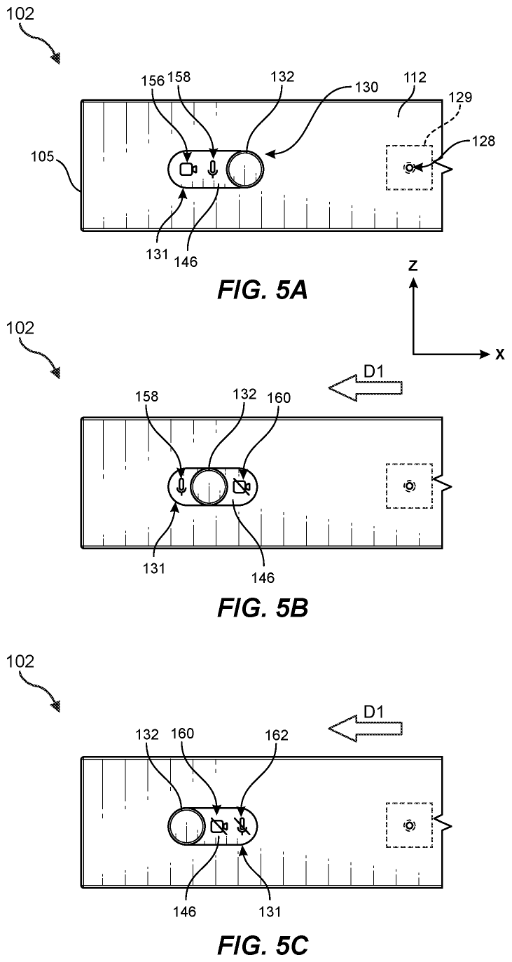

FIGS. 5A-5C illustrate part of display device 102 including portions of privacy switch assembly 130 that are visible to a user from an exterior of display device 102, in accordance with various embodiments. Each of these figures shows portions of privacy switch assembly 130 visible during a different privacy state of display device 102. Privacy states, as used herein, may refer to ON/OFF states of one or more cameras (e.g., camera 136), microphones (e.g., microphones 129), and/or various other sensors, detectors, and/or components capable of gathering and/or conveying information about a user and/or their surroundings. An ON state of a component (e.g., camera 136, microphones 129, etc.), as used herein, may refer to a component state in which the component is operational or capable of being operated in response to, for example, a control signal from a control circuit (e.g., controller 135 in FIG. 3). Conversely, an OFF state of a component, as used herein, may refer to a state in which the component is not operational, or in some instances, a state in which the component is operational but is prevented from capturing information from the environment (e.g., camera 136 may be considered to be in an OFF state when the field of view of camera 136 is blocked by camera shutter 123, even if camera 136 is otherwise capable of being operated).

As shown in FIGS. 5A-5C, positioning protrusion 132 and various portions of privacy indicator surface 146, which is disposed on sliding member 148, may be visible via elongated opening 131. Positioning protrusion 132 may be slidably movable by a user along a length of elongated opening 131 in direction D1, which may be parallel or substantially parallel to the illustrated X-axis, or an opposite direction thereof. Sliding member 148 (see, e.g., FIGS. 6A-9B) and privacy indicator surface 146 may slide in conjunction with movement of positioning protrusion 132 between two or more different set positions. For example, positioning protrusion 132, sliding member 148, and privacy indicator surface 146 may be selectively positioned by the user in at least three different set positions corresponding to various ON/OFF states of camera 136 and microphones 129, as shown in FIGS. 5A-5C.

According to at least one embodiment, privacy indicator surface 146 may include various visual indicator graphics, such as icons, colors, and/or other suitable surface features, designed to immediately convey to a user a privacy state of display device 102 corresponding to each set position of privacy switch assembly 130. Privacy indicator surface 146 may, in at least one example, include a top surface of sliding member 148. In additional embodiments, privacy indicator surface 146 may include a separate layer or panel of material that is disposed on top of sliding member 148 such that privacy indicator surface 146 moves in conjunction with sliding member 148.

FIG. 5A shows a view of positioning protrusion 132 and privacy indicator surface 146 when privacy switch assembly 130 is disposed in a first position with positioning protrusion 132 at a first end of elongated opening 131. While privacy switch assembly 130 is in this first position, portions of privacy indicator surface 146 located to the left of positioning protrusion 132 may be visible to a user located in front of display surface 104. For example, a portion of privacy indicator surface 146 that includes visual icons, such as a camera ON indicator 156 and a microphone ON indicator 158, may be visible to the user via elongated opening 131. Additional portions of privacy indicator surface 146 located to the right of positioning protrusion 132 (from the user's perspective) may not be visible since they are overlapped and blocked from view by top side 112. Camera ON indicator 156 may convey that camera 136 is operational and capturing or capable of capturing images. Additionally, microphone ON indicator 158 may convey to the user that one or more of microphones 129 are operational and capturing or capable of capturing audio. For example, as shown in FIG. 5A, camera ON indicator 156 may include an icon of a camera and microphone ON indicator 158 may include an icon of a microphone.

In some embodiments, at least a portion of privacy indicator surface 146 at or near camera ON indicator 156 and microphone ON indicator 158 may include a color that further conveys the ON states of camera 136 and microphones 129. For example, privacy indicator surface 146 may have a green color, a neutral color (e.g., a color matching the housing color), and/or any other suitable color in a background surrounding at least a portion of camera ON indicator 156 and/or microphone ON indicator 158. Additionally or alternatively, camera ON indicator 156 and/or microphone ON indicator 158 may include a black, white, and/or green color and/or any other suitable color that is different from a color of the background so as to contrast with and stand out visually from the background. Any other suitable colors may additionally or alternatively be utilized to signal the ON states of the components.

FIG. 5B shows a view of positioning protrusion 132 and privacy indicator surface 146 when privacy switch assembly 130 is disposed in a second position corresponding to a second privacy state of display device 102. The second position of the privacy switch assembly 130 shown FIG. 5B may be reached when a user slides positioning protrusion 132 from the first position (see FIG. 5A) in direction D1. In the second privacy state, microphones 129 may be disabled or camera 136 may be disabled and/or covered by camera shutter 123. For example, camera 136 may be disabled and/or blocked by camera shutter 123 while microphones 129 remain active to capture audio from the user's environment. Accordingly, the user may, for example, communicate audibly with other remote individuals via display device 102 while maintaining visual privacy by preventing camera 136 from capturing images from the user's environment. In some embodiments, microphones 129 may be disabled while camera 136 remains active to capture images from the user's environment while preventing capture of audio content via microphones 129.

As shown in FIG. 5B, microphone ON indicator 158 may still be visible but camera ON indicator 156 may be blocked from the user's view by an overlapping portion of top side 112 of housing 105. Additionally, a camera OFF indicator 160 may be visible on a portion of privacy indicator surface 146 located to the right of positioning protrusion 132 from the user's perspective. Camera OFF indicator 160 may convey that camera 136 is not operational and/or is blocked by, for example, camera shutter 123. Camera OFF indicator 160 may include, for example, an icon, such as a camera icon with a line through it indicating an OFF state of camera 136.

FIG. 5C shows a view of positioning protrusion 132 and privacy indicator surface 146 when privacy switch assembly 130 is disposed in a third position corresponding to a third privacy state of display device 102. The third position of the privacy switch assembly 130 shown FIG. 5C may be reached when a user slides positioning protrusion 132 from the second position (see FIG. 5B) in direction D1. In the third privacy state, microphones 129 may be disabled and camera 136 may be disabled and/or covered by camera shutter 123. Accordingly, capture of both sound and images may be prevented when display device 102 is in the third privacy state. A user may select the third privacy state to, for example, prevent display device 102 from capturing sound and images from the user's surroundings. In some embodiments, the third privacy state may be utilized by a user to, for example, prevent inadvertent and/or malicious capture of sound and images when the user is not using display device 102.

As illustrated in FIG. 5C, when privacy switch assembly 130 is in the third position, positioning protrusion 132 may be disposed at an end of elongated opening 131 opposite the end at which positioning protrusion 132 is located when privacy switch assembly 130 is in the first position illustrated in FIG. 5A. Accordingly, as shown in FIG. 5C, a portion of privacy indicator surface 146 located to the left of positioning protrusion 132 from the user's perspective may be blocked from view by an overlapping portion of top side 112. Camera OFF indicator 160 and a microphone OFF indicator 162 may be visible on privacy indicator surface 146 at a location to the right of positioning protrusion 132. Microphone OFF indicator 162 may convey that one or more of microphones 129 are not operational and/or are prevented from operating (e.g., by interrupting a wiring path between controller 135 and microphones 129). Microphone OFF indicator 162 may, in some examples, include an icon, such as a microphone icon with a line through it indicating an OFF state of microphones 129. Accordingly, users may readily see that both camera 136 and microphones 129 are not active when privacy switch assembly 130 is in the third position shown in FIG. 5C.

In some examples, a portion of privacy indicator surface 146 at or near camera OFF indicator 160 and microphone OFF indicator 162 may include a color that further conveys the OFF states of camera 136 and microphones 129. For example, privacy indicator surface 146 may include, in a background surrounding at least a portion of camera OFF indicator 160 and/or microphone OFF indicator 162, a red color and/or any other suitable color that differs from a background color surrounding camera ON indicator 156 and microphone ON indicator 158. Additionally or alternatively, camera OFF indicator 160 and/or microphone OFF indicator 162 may include a black, white, and/or red color and/or any other suitable color that is different from a color of the background so as to contrast with and stand out visually from the background. Any other suitable colors may additionally or alternatively be utilized to signal the OFF states of the components. Accordingly, a user may immediately recognize the privacy states of camera 136 and microphones 129 in each of the set positions of privacy switch assembly 130 illustrated in each of FIGS. 5A-5C.

FIGS. 6A-9B show various components of privacy switch assembly 130, including components disposed within housing 105 of display device 102, in each of the set positions of privacy switch assembly 130 illustrated in FIGS. 5A-5C. According to some embodiments, FIGS. 6A shows a front view and FIG. 6B shows a cross-sectional top view of privacy switch assembly 130 and camera 136.

FIGS. 6A and 6B show components of privacy switch assembly 130 when privacy switch assembly 130 is disposed in the first position illustrated in FIG. 5A. As shown in FIGS. 6A and 6B, sliding member 148 may be in a first position and camera shutter 123 may be disposed at a first shutter location so as to not overlap camera lens 150 of camera 136. Accordingly, when sliding member 148 is in the first position, a field of view of camera 136 may not be obscured. In various embodiments, camera 136 and one or more of microphones 129 may be in an ON state when sliding member 148 is in the first position.

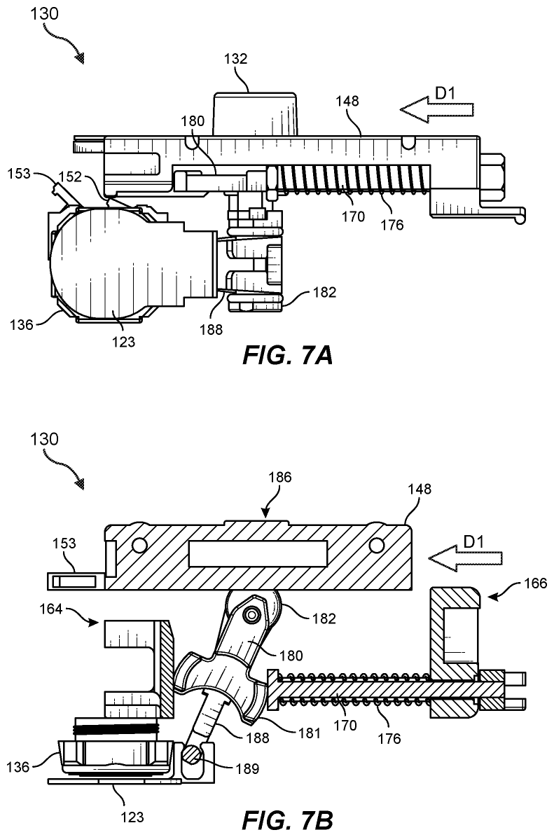

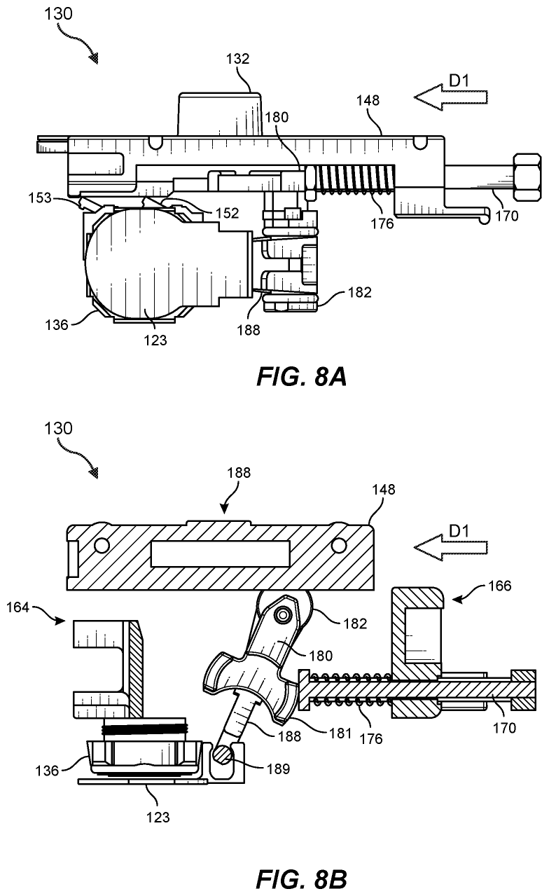

In some examples, display device 102 may include one or more switches, such as primary switch 152 and secondary switch 153, which may be utilized to disable camera 136 and/or microphones 129, as will be described in greater detail below in conjunction with FIGS. 7A and 8A. As shown in FIGS. 6A and 6B, when sliding member 148 is in the first position, primary and secondary switches 152 and 153 may not be in a triggered state. In at least one example, primary and secondary switches 152 and 153 may be triggered based on the location of sliding member 148 to disable camera 136 and/or microphones 129. Positioning protrusion 132 may be fixed to sliding member 148 such that sliding member 148 slides parallel or substantially parallel to the X-axis in conjunction with corresponding movement of positioning protrusion 132. Sliding member 148 may extend between a left portion 164 and a right portion 166. Privacy indicator surface 146 may be disposed on an upper portion 168 of sliding member 148 and may surround positioning protrusion 132, which may be disposed at a location between left portion 164 and right portion 166. In some embodiments, sliding member 148 may also include a recessed region 167 defined in a lower part of sliding member 148 between left portion 164, right portion 166, and a back portion 186, as shown in FIGS. 6A and 6B.

According to at least one embodiment, privacy switch assembly 130 may also include an input lever 180 disposed within recessed region 167 for transferring force from sliding member 148 to camera shutter 123 to reposition camera shutter 123. Input lever 180 may be rotatable about a rotational axis 184 and may include an input region 181 positioned to receive a load transferred from sliding member 148. Forces transferred to input region 181 via movement of sliding member 148 may cause rotation of input lever 180 and a connected transfer shaft 182 about rotational axis 184 in the clockwise direction as viewed in FIG. 6B. Transfer shaft 182 may be fixed to an end portion of input lever 180 opposite input region 181. Privacy switch assembly 130 may further include an output lever 188 that is fixed to transfer shaft 182 such that output lever 188 rotates in conjunction with transfer shaft 182 and input lever 180. Input lever 180 and output lever 188 may extend in any suitable directions relative to one another, such as directions that are parallel or generally parallel to each other as shown in FIG. 6B.

Output lever 188 may rotate about rotational axis 184 and may include an output region 189 at an end opposite a portion coupled to transfer shaft 182. Output region 189 may apply an output force to camera shutter 123 as output lever 188 is rotated. For example, output region 189 may be disposed within a coupling slot 190 of camera shutter 123 that allows for a limited range of movement of output region 189 within coupling slot 190 as output region 189 pushes against one or more sides of coupling slot 190. Thus, rotational movement of output lever 188 may cause corresponding movement of camera shutter 123, as will be described below in reference to FIGS. 7A-8B. In some embodiments, movement of camera shutter 123 may be constrained so that camera shutter moves the linearly or substantially linearly in a direction parallel or substantially parallel to the X-axis in response to forces applied by output lever 188.

In various examples, input region 181 of input lever 180 may be located at a distance from rotational axis 184 that is less than a distance between output region 189 of output lever 188 and rotational axis 184. Accordingly, as forces are applied to input lever 180 during movement of sliding member 148, causing input lever 180 and output lever 188 to simultaneously rotate about rotational axis 184, output region 189 of output lever 188 may traverse a greater distance than input region 181 of input lever 180. Accordingly camera shutter 123 may move a greater cumulative distance in a direction parallel to the X-axis than sliding member 148 as sliding member 148 is moved between various set positions.

According to at least one embodiment, privacy switch assembly 130 may also include a holding member 170 (e.g., a partially threaded bolt) that abuts a portion of input region 181 of input lever 180. In some examples, holding member 170 may include a shank 172 that extends longitudinally in a direction parallel or substantially parallel to the X-direction between, for example, a head 174 abutting input region 181 and an opposite end that is coupled (e.g., threadedly coupled) to a nut 178 or other suitable fastening member. As illustrated in FIG. 6B, a portion of shank 172 of holding member 170 may extend through a hole 177 defined in right portion 166 of sliding member 148. Hole 177 may couple holding member 170 to sliding member 148 in a selected orientation while allowing slidable movement of shank 172 through hole 177 in a direction parallel or substantially parallel to the X-axis. As illustrated, a biasing member, such as a spring 176 (e.g., a compression spring) may surround at least a portion of shank 172 of holding member 170 between head 174 and a surface of right portion 166 of sliding member 148 defining recessed region 167. In the first position of sliding member 148 shown in FIGS. 6A and 6B, holding member 170 may be extended by spring 176 such that head 174 abuts input region 181 of input lever 180.

FIGS. 7A and 7B show components of privacy switch assembly 130 when privacy switch assembly 130 is disposed in the second position illustrated in FIG. 5B. FIG. 7A shows a front view and FIG. 7B shows a cross-sectional top view of privacy switch assembly 130 and camera 136. As illustrated in these figures, sliding member 148 may be moved by a user via positioning protrusion 132 in direction D1, which is parallel or substantially parallel to the X-axis. As shown, sliding member 148 may be disposed in a second position located a selected distance in direction D1 relative to the first position shown in FIGS. 6A and 6B. Additionally, camera shutter 123 may be disposed over camera lens 150 of camera 136 at a second shutter location, which is located in direction D1 relative to the first shutter location illustrated in FIGS. 6A and 6B. Camera shutter 123 may overlap camera opening 122 (see, e.g., FIG. 1) so as to block a field of view of camera 136.

In at least one embodiment, as sliding member 148 moves in direction D1, transfer shaft 182 may be held at a fixed position in display device 102. For example, transfer shaft 182 may be rotatably fixed to a support portion of display device 102. Accordingly as sliding member 148 moves, holding member 170 may be forced in direction D1 in conjunction with sliding member 148, with head 174 of holding member 170 abutting input region 181 of input lever 180 so that input lever 180 and transfer shaft 182 are rotated about rotational axis 184 (i.e., in a clockwise direction relative to the viewer shown in FIG. 7B). Likewise, input lever 180 may also force, via transfer shaft 182, rotation of output lever 188 about rotational axis 184 such that output region 189 of output lever 188 forces camera shutter 123 in direction D1. As discussed above, since output region 189 of output lever 188 is disposed at a greater distance from rotational axis 184 than input region 181 of input lever 180, output region 189 and camera shutter 123 may traverse a greater distance between the first shutter location and the second shutter location than a distance traversed by sliding member 148 between the first position and the second position in direction D1 (see FIGS. 6A-7B). Thus, an amount of movement required for positioning sliding member 148 so as to arrange camera shutter 123 over a field of view of camera 136 may be minimized.

In some embodiments, sliding member 148 may be moved from a location separated from primary switch 152 (see FIG. 6A) to a position that overlaps and triggers primary switch 152. For example, as shown in FIG. 7A, back portion 186 of sliding member 148 may contact and move an extended arm of primary switch 152 to trigger primary switch 152 and disable camera 136. As such, in addition to camera 136 being blocked by camera shutter 123, camera 136 may also be disabled in response to triggering of primary switch 152, thereby providing users with an added layer of privacy and security by preventing capture of images when camera 136 is covered by camera shutter 123. For example, primary switch 152 may send a signal, such as a disable signal, to a controller (see controller 135 in FIG. 3) that controls camera 136. Controller 135 may in turn disable image capture by camera 136 (e.g., camera 136 may be switched to a standby or OFF state). In certain embodiments, movement of sliding member 148 to, for example, the second position shown in FIGS. 5B, 7A, and 7B may cause an electrical disconnection between camera 136 and controller 135 to prevent communication between camera 136 and controller 135. For example, primary switch 152 may interrupt an electrical connection between camera 136 and controller 135 when triggered, providing enhanced privacy to users by ensuring that camera 136 is not inadvertently or maliciously operated (e.g., by a third party with unauthorized access to display device 102) without the users' knowledge or authorization.

In certain embodiments, camera shutter 123 may be designed to visually indicate to a user that camera 136 is blocked. For example, at least a portion of camera 136 and/or a region surrounding camera 136 that is visible to the user via camera opening 122 (see, e.g., FIGS. 1 and 2) may have colors or other visible surface features that indicate to the user that camera 136 is in an ON state. Additionally, camera shutter 123 may have a physical appearance that differs from camera 136 in, for example, color, surface pattern, and/or other suitable visual characteristics. Accordingly, when camera shutter 123 covers camera 136 such that at least a portion of camera shutter 123 is visible via camera opening 122, it may be readily apparent to the user that camera 136 is indeed blocked by camera shutter 123, thereby giving the user a greater sense of privacy and security based on the protection against unwanted image capture provided by camera shutter 123.

In some embodiments, sliding member 148 of privacy switch assembly 130 may also be moved in a direction opposite direction D1 from the second position of FIGS. 7A and 7B to the first position shown in FIGS. 6A and 6B. During movement of sliding member 148 to the first position, an inner surface of left portion 164 of sliding member 148 may apply a force to input region 181 of input lever 180, causing rotation of input lever 180 and output lever 188 about rotational axis 184 in a counter-clockwise direction (as viewed in FIG. 7B). Output region 189 of output lever 188 may force camera shutter 123 in the direction opposite direction D1 such that camera shutter 123 no longer covers camera 136.

FIGS. 8A and 8B show components of privacy switch assembly 130 when privacy switch assembly 130 is disposed in the third position illustrated FIG. 5C. FIG. 8A shows a front view and FIG. 8B shows a cross-sectional top view of privacy switch assembly 130 and camera 136. As illustrated in these figures, sliding member 148 may be further moved by a user via positioning protrusion 132 in direction D1. As shown, sliding member 148 may be disposed in a third position located a selected distance in direction D1 relative to the second position shown in FIGS. 7A and 7B.

In at least one embodiment, as sliding member 148 moves in direction D1, input lever 180 and/or camera shutter 123 may be prevented from further movement in conjunction with sliding member 148 in direction D1. Any suitable stop mechanism may be utilized to prevent further movement of input lever 180 and/or camera shutter 123. For example, a portion of camera shutter 123 defining coupling slot 190 may abut a peripheral portion of camera 136 so as to prevent further movement of camera shutter 123 in direction D1. Likewise, output lever 188, transfer shaft 182, and/or input lever 180 may be prevented from further rotating in the clockwise direction of FIG. 8B. Accordingly, as sliding member 148 is forced in direction D1, holding member 170, which abuts input lever 180 at head 174, may also be prevented from further movement in direction D1. As such, right portion 166 of sliding member 148 may slide along shank 172 of holding member 170, which is disposed in hole 177, in direction D1 as it compresses spring 176, thereby allowing for continued movement of sliding member 148 to the third position shown in FIGS. 8A and 8B while maintaining the position of camera shutter 123 overlapping the field of view of camera 136. Conversely, in some embodiments, when sliding member 148 is moved back to the second position shown in FIGS. 7A and 7B, spring 176 may expand and maintain a biasing force holding head 174 of holding member 170 against input region 181 of input lever 180 so as to hold camera shutter 123 over the field of view of camera 136.

Returning to FIGS. 8A and 8B, when sliding member 148 is located in the third position, left portion 164 of sliding member 148 may trigger secondary switch 153 by contacting and moving an extended arm of secondary switch 153. In some embodiments, when secondary switch 153 is triggered, microphones 129 may be disabled. For example, secondary switch 153 may send a signal, such as a disable signal, to a controller (such as controller 135 in FIG. 3) that controls microphones 129. Controller 135 may in turn disable audio capture via microphones 129 (e.g., microphones 129 may be muted and/or switched to an OFF state). In certain embodiments, movement of sliding member 148 to, for example, the third position shown in FIGS. 5C, 8A, and 8B may cause an electrical disconnection between controller 135 and microphones 129 to prevent communication between microphones 129 and controller 135. For example, secondary switch 153 may interrupt an electrical connection between microphones 129 and controller 135 when triggered, providing enhanced privacy to users by ensuring that microphones 129 are not inadvertently or maliciously operated (via, e.g., controller 135) without the users' knowledge or authorization.

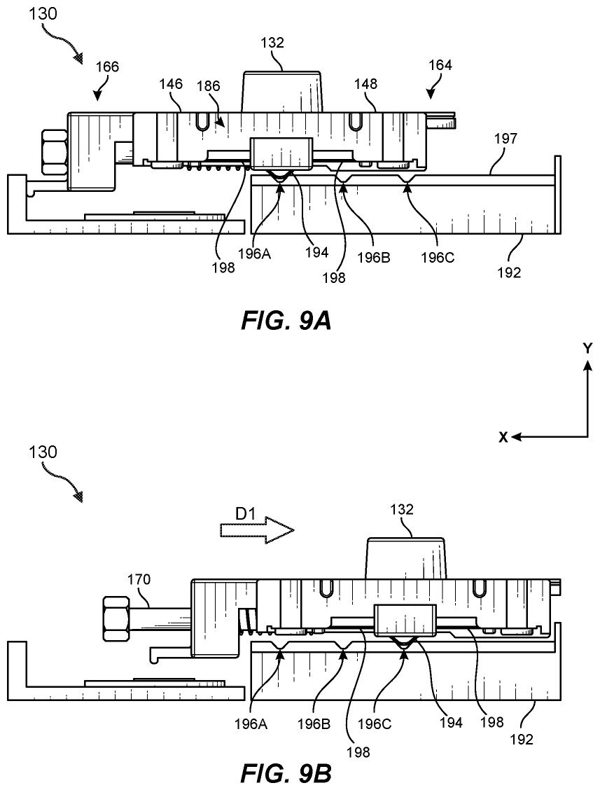

FIGS. 9A and 9B are rear views of components of privacy switch assembly 130 showing exemplary position holding features for securing portions privacy switch assembly 130 in various set positions as described herein. FIG. 9A illustrates, for example, privacy switch assembly 130 in a first position as shown in FIGS. 5A, 6A, and 6B. FIG. 9B illustrates privacy switch assembly 130 in third position as shown in FIGS. 5C, 8A, and 8B any suitable mechanism may be utilized to securely holding privacy switch assembly 130 at the various set positions while allowing for user-controlled movement between the set positions as described herein.

According to some embodiments, back portion 186 of sliding member 148 may be positioned over a fixed base 192 as shown. Fixed based 192 may, for example, include various holding elements dimensioned and configured to allow for movement of sliding member 148 between a plurality of set positions, such as the first, second, and third positions described herein, in response to a force applied by a user to positioning protrusion 132. The holding elements may then securely hold sliding member 148 in one of the set positions selected by the user to maintain a selected privacy state of display device 102.

In at least one embodiment, as shown in FIGS. 9A and 9B, a detent mechanism may be used to selectively position and hold sliding member 148. For example, sliding member 148 may include a detent member 194 having a shape that is dimensioned to engage with corresponding detent recesses, such as first, second, and third detent recesses 196A, 196B, and 196C. Detent member may be formed of a resilient material (e.g., a metal, polymeric, composite, and/or other material having a suitable degree of shape memory). Detent member 194 may protrude toward fixed base 192 and may be coupled to sliding member 148 via, for example, spring portions 198 extending from each side of detent member 194. In at least one example, spring portions 198 and detent member 194 may be formed of a single length of material that is bent to form detent member 194 extending from spring portions 198, which may extend along a linear or substantially linear path or any other suitable path. Spring portions 198 may flex when a force is applied by a user generally in the direction of the X-axis, allowing detent member 194 to slide along a portion of a top surface 197 of fixed base 192 between detent recesses 196A, 196B, and 196C. When detent member 194 is positioned in one of the detent recesses 196A, 196B, and 196C, spring portions 198 may force detent member 194 into secure abutment with portions of fixed base 192 defining the detent recess.

FIG. 9A illustrates sliding member 148 of privacy switch assembly 130 in a first position with detent member 194 secured in first detent recess 196A. A user may move sliding member 148 in direction D1 to move sliding member 148 to the second and third positions described herein. For example, detent member 194 may be secured in second detent recess 196B to hold sliding member 148 in the second position (see, e.g., FIGS. 5B, 7A, and 7B). Additionally, detent member 194 may be secured in third detent recess 196C to hold sliding member 148 in the third position, as shown in FIG. 9B (see also FIGS. 5C, 8A, and 8B). Accordingly, the user may readily position and maintain the position of privacy switch assembly 130 as desired.

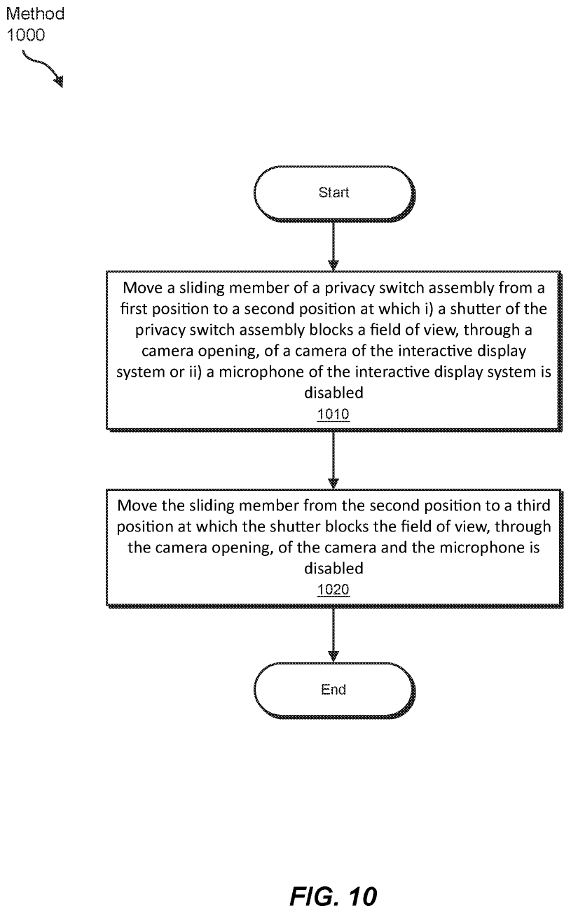

FIG. 10 is a flow diagram of an exemplary method 1000 for operating a privacy switch assembly of an interactive display system in accordance with some embodiments. As illustrated in FIG. 10, at step 1010, a sliding member of a privacy switch assembly of the interactive display system may be moved from a first position to a second position at which i) a shutter of the privacy switch assembly blocks a field of view, through a camera opening, of a camera of the interactive display system or ii) a microphone of the interactive display system is disabled. In some examples, at the first position of the sliding member, a field of view of the camera through the camera opening may be unobstructed and the microphone may be active.

For example, as described in greater detail above, an interactive display system 100 may include housing 105 surrounding at least a portion of display region (i.e., display surface 104), camera 136 for capturing images via camera opening 122 defined in housing 105, and microphones 129 for capturing audio content. Sliding member 148 of privacy switch assembly 130 of interactive display system 100 may be moved from a first position (see, e.g., FIGS. 2, 4, 5A, 6A, 6B, and 9A) to a second position (see, e.g., FIGS. 5B, 7A, and 7B). In some examples, at the first position of sliding member 148, a field of view of camera 136 through camera opening 122 may be unobstructed and at least one of microphones 129 may be active. Additionally, at the second position of sliding member 148, either i) a camera shutter 123 of the privacy switch assembly 130 may block a field of view of camera 136 through camera opening 122 or ii) microphones 129 may be disabled.

At step 1020, the sliding member may be moved from the second position to a third position at which the shutter blocks the field of view, through the camera opening, of the camera and the microphone is disabled. For example, sliding member 148 may be moved from the second position to a third position at which both i) camera shutter 123 blocks the field of view, through camera opening 122, of camera 136 and ii) microphones 129 are disabled (see, e.g., FIGS. 1, 5C, 8A, 8B, and 9B).

In some embodiments, moving the sliding member from the first position to the second position may cause the shutter to move from a first shutter location not overlapping the camera opening to a second shutter location overlapping the camera opening. For example, moving sliding member 148 from the first position to the second position may cause camera shutter 123 to move from a first shutter location not overlapping camera opening 122 (see, e.g., FIGS. 2, 4, 5A, 6A, 6B, and 9A) to a second shutter location overlapping camera opening 122 (see, e.g., FIGS. 1, 5B, 5C, 7A-8B, and 9B). Additionally, in this example, the shutter may remain in the second shutter location overlapping the camera opening as the sliding member is moved from the second position to the third position at which the microphone is disabled. For example, camera shutter 123 may remain in the second shutter location overlapping camera opening 122 as sliding member 148 is moved from the second position to the third position at which microphones 129 are disabled (see, e.g., FIGS. 5C, 8A, and 8C).

Example Embodiments

Example 1: An interactive display system may include (1) a housing surrounding at least a portion of a display region, (2) a camera for capturing images via a camera opening defined in the housing, (3) a microphone for capturing audio content, and (4) a privacy switch assembly including a sliding member fixed to a positioning protrusion that is accessible by a user at the housing exterior to enable the user to move the sliding member between a plurality of set positions including (i) a first position at which a field of view of the camera is unobstructed and the microphone is active, (ii) a second position at which a shutter of the privacy switch assembly blocks the field of view of the camera or the microphone is disabled, and (iii) a third position at which the shutter blocks the field of view of the camera and the microphone is disabled.

Example 2: The interactive display system of example 1, wherein at least a portion of the sliding member may be disposed within the housing and the positioning protrusion may extend through an elongated opening defined in an exterior side of the housing such that the positioning protrusion is movable along the length of the elongated opening in conjunction with movement of the sliding member between the plurality of set positions.

Example 3: The interactive display system of example 2, wherein a portion of a privacy indicator surface of the sliding member may be externally visible via the elongated opening, the privacy indicator surface providing a visual indication of a privacy state of the camera and a privacy state of the microphone corresponding to each of the plurality of set positions of the sliding member, and wherein another portion of the privacy indicator surface is blocked from external view by the exterior surface of the housing.

Example 4: The interactive display system of example 3, wherein the privacy indicator surface may include a plurality of indicator graphics and a separate combination of indicator graphics may be visible via the elongated opening when the sliding member is in each of the plurality of set positions.

Example 5: The interactive display system of any of examples 1-4, further including at least one switch that may be triggered when the sliding member is in at least one of the second position or the third position, wherein at least one of the camera or the microphone may be disabled in response to triggering the at least one switch.

Example 6: The interactive display system of example 5, wherein the at least one switch may include (i) a primary switch that is triggered to disable the camera when the sliding member is in the second position and (ii) a secondary switch that is triggered to disable the microphone when the sliding member is in the third position.

Example 7: The interactive display system of any of examples 1-6, wherein the microphone may be disabled by at least one of (i) sending a disable signal to a controller controlling the microphone or (ii) interrupting an electrical connection between the controller and the microphone.

Example 8: The interactive display system of any of examples 1-7, wherein the shutter may move from a first shutter location not overlapping the camera opening to a second shutter location overlapping the camera opening as the sliding member is moved from the first position to the second position.

Example 9: The interactive display system of example 8, wherein the shutter may remain in the second shutter location overlapping the camera opening as the sliding member is moved from the second position to the third position at which the microphone is disabled.

Example 10: The display system of example 8 or example 9, wherein the shutter may traverse a greater distance between the first shutter location and the second shutter location than a distance traversed by the sliding member between the first position and the second position.

Example 11: The display system of any of examples 8-10, wherein (i) the sliding member may apply a first force to an input lever of the privacy switch assembly, causing rotation of the input lever, as the sliding member is moved from the first position to the second position, and (ii) the input lever may be fixed to an output lever of the privacy switch assembly that rotates in conjunction with the rotation of the input lever so as to apply a second force to the shutter, which is coupled to the output lever, resulting in the movement of the shutter from the first shutter location to the second shutter location.

Example 12: The display system of example 11, wherein (i) the input lever may be fixed to the output lever via a transfer shaft that is rotatable about a rotational axis in conjunction with the rotation of the input lever and the output lever, and (ii) a region of the output lever that applies the second force to the shutter may be located at a greater distance from the rotational axis than a region of the input lever that receives the first force applied by the sliding member.

Example 13: The display system of example 11 or example 12, wherein the privacy switch assembly may further include a spring that biases the input lever so as to hold the shutter in the second shutter location as the sliding member is moved from the second position to the third position.

Example 14: A privacy switch assembly for an interactive display device may include (1) a shutter configured to selectively block a field of view a camera of the interactive display device, and (2) a sliding member that is movable by a user between a plurality of set positions including (i) a first position at which a field of view of the camera through a camera opening of the interactive display device is unobstructed and a microphone of the interactive display device is active, (ii) a second position at which the shutter blocks the field of view of the camera through the camera opening or the microphone is disabled, and (iii) a third position at which the shutter blocks the field of view of the camera through the camera opening and the microphone is disabled.

Example 15: The privacy switch assembly of example 14, wherein the sliding member may include a privacy indicator surface for providing a visual indication of a privacy state of the camera and a privacy state of the microphone corresponding to each of the plurality of set positions of the sliding member.

Example 16: The privacy switch assembly of example 14 or example 15, wherein the shutter may move from a first shutter location not overlapping the camera opening to a second shutter location overlapping the camera opening as the sliding member is moved from the first position to the second position.

Example 17: The privacy switch assembly of example 16, wherein the shutter may remain in the second shutter location overlapping the camera opening as the sliding member is moved from the second position to the third position at which the microphone is disabled.

Example 18: A method may include (1) moving a sliding member of a privacy switch assembly of an interactive display system from a first position to a second position, the interactive display system including a housing surrounding at least a portion of a display region, a camera for capturing images via a camera opening defined in the housing, and a microphone for capturing audio content, wherein (i) at the first position of the sliding member, a field of view of the camera through the camera opening is unobstructed and the microphone is active, and (ii) at the second position of the sliding member, a shutter of the privacy switch assembly blocks the field of view of the camera through the camera opening or the microphone is disabled, and (2) moving the sliding member from the second position to a third position at which the shutter blocks the field of view of the camera through the camera opening and the microphone is disabled.

Example 19: The method of example 18, wherein moving the sliding member from the first position to the second position may cause the shutter to move from a first shutter location not overlapping the camera opening to a second shutter location overlapping the camera opening.

Example 20: The method of example, 19, wherein the shutter may remain in the second shutter location overlapping the camera opening as the sliding member is moved from the second position to the third position at which the microphone is disabled.

Computing devices and systems described and/or illustrated herein, such as those included in the illustrated display devices, broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An interactive display system comprising:
a housing surrounding at least a portion of a display region;
a camera for capturing images via a camera opening defined in the housing;
a microphone for capturing audio content; and
a privacy switch assembly comprising a sliding member fixed to a positioning protrusion that is accessible by a user at the housing exterior to enable the user to move the sliding member between a plurality of set positions comprising:
a first position at which a field of view of the camera through the camera opening is unobstructed and the microphone is active;
a second position at which a shutter of the privacy switch assembly blocks the field of view of the camera through the camera opening or the microphone is disabled; and
a third position at which the shutter blocks the field of view of the camera through the camera opening and the microphone is disabled.

2. The interactive display system of claim 1, wherein:
at least a portion of the sliding member is disposed within the housing; and
the positioning protrusion extends through an elongated opening defined in an exterior side of the housing such that the positioning protrusion is movable along a length of the elongated opening in conjunction with movement of the sliding member between the plurality of set positions.

3. The interactive display system of claim 2, wherein:
a portion of a privacy indicator surface of the sliding member is externally visible via the elongated opening, the privacy indicator surface providing a visual indication of a privacy state of the camera and a privacy state of the microphone corresponding to each of the plurality of set positions of the sliding member; and
another portion of the privacy indicator surface is blocked from external view by the exterior side of the housing.

4. The interactive display system of claim 3, wherein:
the privacy indicator surface comprises a plurality of indicator graphics; and
a separate combination of indicator graphics is visible via the elongated opening when the sliding member is in each of the plurality of set positions.

5. The interactive display system of claim 1, further comprising at least one switch that is triggered when the sliding member is in at least one of the second position or the third position, wherein at least one of the camera or the microphone is disabled in response to triggering the at least one switch.

6. The interactive display system of claim 5, wherein the at least one switch comprises:
a primary switch that is triggered to disable the camera when the sliding member is in the second position; and
a secondary switch that is triggered to disable the microphone when the sliding member is in the third position.

7. The interactive display system of claim 1, wherein the microphone is disabled by at least one of:
sending a disable signal to a controller controlling the microphone; or interrupting an electrical connection between the controller and the microphone.

8. The interactive display system of claim 1, wherein the shutter moves from a first shutter location not overlapping the camera opening to a second shutter location overlapping the camera opening as the sliding member is moved from the first position to the second position.

9. The interactive display system of claim 8, wherein the shutter remains in the second shutter location overlapping the camera opening as the sliding member is moved from the second position to the third position at which the microphone is disabled.

10. The interactive display system of claim 8, wherein the shutter traverses a greater distance between the first shutter location and the second shutter location than a distance traversed by the sliding member between the first position and the second position.

11. The interactive display system of claim 8, wherein:
the sliding member applies a first force to an input lever of the privacy switch assembly, causing rotation of the input lever, as the sliding member is moved from the first position to the second position; and
the input lever is fixed to an output lever of the privacy switch assembly that rotates in conjunction with the rotation of the input lever so as to apply a second force to the shutter, which is coupled to the output lever, resulting in the movement of the shutter from the first shutter location to the second shutter location.

12. The interactive display system of claim 11, wherein:
the input lever is fixed to the output lever via a transfer shaft that is rotatable about a rotational axis in conjunction with the rotation of the input lever and the output lever; and
a region of the output lever that applies the second force to the shutter is located at a greater distance from the rotational axis than a region of the input lever that receives the first force applied by the sliding member.

13. The interactive display system of claim 11, wherein the privacy switch assembly further comprises a spring that biases the input lever so as to hold the shutter in the second shutter location as the sliding member is moved from the second position to the third position.

14. A privacy switch assembly for an interactive display device comprising:
a shutter configured to selectively block a field of view a camera of the interactive display device; and
a sliding member that is movable by a user between a plurality of set positions comprising:
a first position at which a field of view of the camera through a camera opening of the interactive display device is unobstructed and a microphone of the interactive display device is active;
a second position at which the shutter blocks the field of view of the camera through the camera opening or the microphone is disabled; and
a third position at which the shutter blocks the field of view of the camera through the camera opening and the microphone is disabled.

15. The privacy switch assembly of claim 14, wherein the sliding member comprises a privacy indicator surface for providing a visual indication of a privacy state of the camera and a privacy state of the microphone corresponding to each of the plurality of set positions of the sliding member.

16. The privacy switch assembly of claim 14, wherein the shutter moves from a first shutter location not overlapping the camera opening to a second shutter location overlapping the camera opening as the sliding member is moved from the first position to the second position.

17. The privacy switch assembly of claim 16, wherein the shutter remains in the second shutter location overlapping the camera opening as the sliding member is moved from the second position to the third position at which the microphone is disabled.

18. A method comprising:
moving a sliding member of a privacy switch assembly of an interactive display system from a first position to a second position, the interactive display system comprising a housing surrounding at least a portion of a display region, a camera for capturing images via a camera opening defined in the housing, and a microphone for capturing audio content, wherein:
at the first position of the sliding member, a field of view of the camera through the camera opening is unobstructed and the microphone is active; and
at the second position of the sliding member, a shutter of the privacy switch assembly blocks the field of view of the camera through the camera opening or the microphone is disabled; and
moving the sliding member from the second position to a third position at which the shutter blocks the field of view of the camera through the camera opening and the microphone is disabled.

19. The method of claim 18, wherein moving the sliding member from the first position to the second position causes the shutter to move from a first shutter location not overlapping the camera opening to a second shutter location overlapping the camera opening.

20. The method of claim 19, wherein the shutter remains in the second shutter location overlapping the camera opening as the sliding member is moved from the second position to the third position at which the microphone is disabled.
